(19) United States
(12) Patent Application Publication
(10) Pub. No.: US 2007/0130071 A1
(43) Pub. Date: Jun. 7, 2007

(54) Information management system, information management method, and program product therefor

(75) Inventor: Kohji Suzuki, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/482,167

(22) Filed: Jul. 7, 2006

(30) Foreign Application Priority Data
Nov. 22, 2005 (JP) 2005-337482

(51) Int. Cl. G06Q 99/00

(52) U.S. Cl. 705/50

(57) ABSTRACT

An information management system includes a determining portion that determines the number of pieces of information to be encrypted by an encryption key, depending on a processing ability of an information terminal that displays an electronic file, in which one or more pieces of the information are stored and encrypted for delivery.

### BACKGROUND

1. Technical Field

This invention generally relates to an information management system, an information management method, and a program product therefor, so that an electronic file in which customer information is stored is encrypted for secure use.

2. Related Art

Conventionally, a length of an encryption key used in the protection of the file in which the customer information is included generally employs the key length predetermined by a system or security policies. For instance, in a case where the customer information is viewed with the use of International version of Microsoft Internet Explorer 4.x, three fixed key lengths for the RSA public-key cryptosystem, namely, 512, 768, and 1,024 bits, are utilized.

It is to be noted that there is a drawback in employing the above-described fixed key length. An example is a case where the security strength equal to or more than 1,024 bits is needed, such as a great number of credit card numbers are storedina file having thecustomer information. In addition, even in a case where the customer information is sufficiently managed with the degree of secrecy relatively low and simply protected, it is impossible to encrypt the file with a smaller key size than 512 bits in order to shorten the processing time. Furthermore, the above-described encryption method employs fixed key lengths of multiples of 256 bits. Accordingly, excessive protection or insufficient protection is often implemented for the file having the customer information. Then, the above conventional method requires more time than necessary to decrypt an encrypted file, and this implies that it is difficult for users to view the encrypted file with the use of a low-performance device such as a mobile telephone, and the like.

### SUMMARY

The present invention has been made in view of the above circumstances and provides an information management system, an information management method, and a program product therefor, in which the processing time and the computational complexity needed for encryption and decryption can be optimized.

According to an aspect of the invention, there is provided an information management system including a determining portion that determines the number of pieces of information to be encrypted by an encryption key, depending on a processing ability of an information terminal that displays an electronic file, in which one or more pieces of the information are stored and encrypted for delivery.

### BRIEF DESCRIPTION OF THE DRAWINGS

Embodiments of the present invention will be described in detail based on the following figures, wherein:

FIG. 1 illustrates relationships of a person, servers, and the like involved in the delivery and view of an electronic file according to an exemplary embodiment of the present invention;

FIG. 2 shows a block diagram of an information terminal owned by a user and that of a customer information management server according to an exemplary embodiment of the present invention;

FIG. 3 shows a procedure to be implemented by the user who uses the electronic file; and

FIG. 4 shows a procedure of the customer information management server in which the electronic file is encrypted and the electronic ticket and the encrypted electronic file are sent.

### DETAILED DESCRIPTION

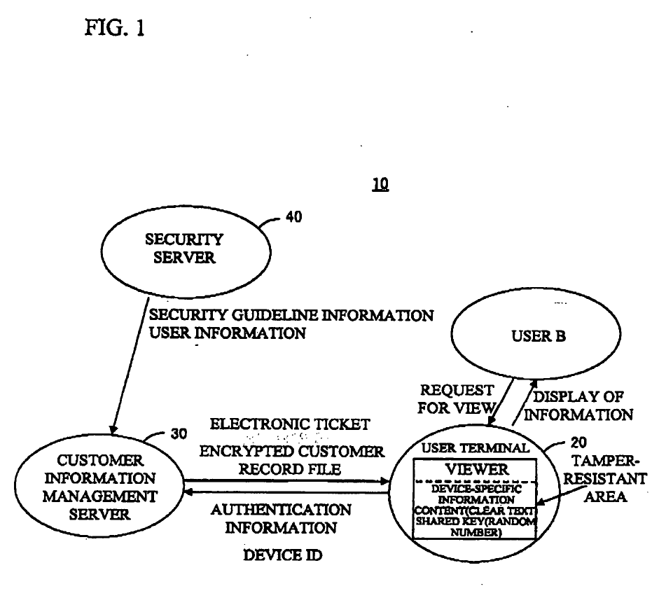

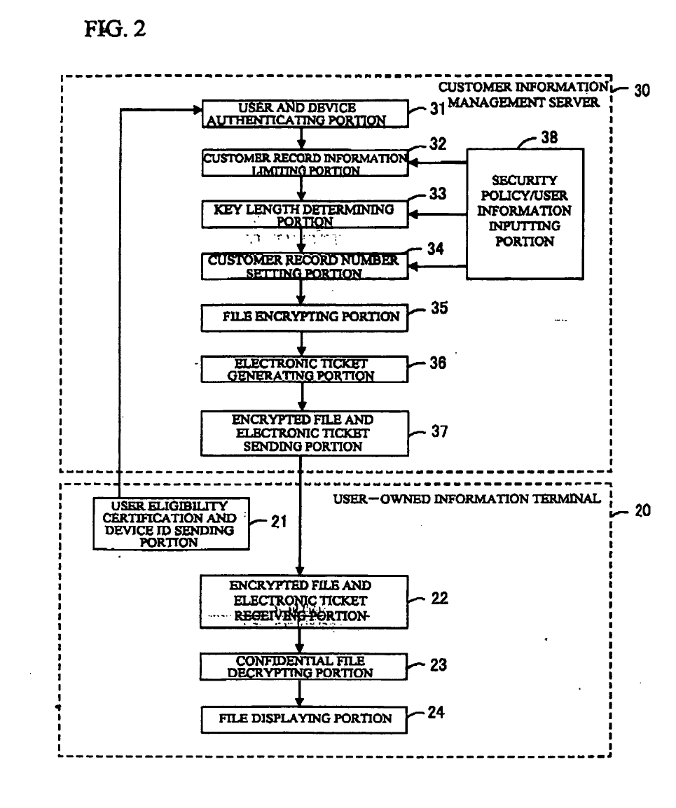

A description will now be given, with reference to the accompanying drawings, of embodiments of the present invention. FIG. 1 illustrates relationships of a user, servers, and the like involved in the delivery and view of an electronic file. FIG. 2 shows a block diagram of a user-owned information terminal and that of a customer information management server. Firstly, by reference to FIG. 1, a description is given of a customer information management system 10 according to an exemplary embodiment of the present invention. The information management system 10 encrypts an electronic file that stores one or more records (information) and provides such encrypted electronic file, and includes a user-owned information terminal (hereinafter, simply referred to as user terminal) 10, acustomer information management server 30, and a security server 40. According to an exemplary embodiment of the present invention, a description will be given of an example where a user B, who is a sales person of a company A, downloads a confidential file having the customer information to a user-owned information terminal 20 by way of an in-house Local Area Network (LAN) to view the confidential file for business activities.

Referring now to FIG. 2, the customer information management server 30 is provided with a user and device authenticating portion 31, a customer record information limiting portion 32, a key length determining portion 33, a customer record number setting portion 34 that serves as a determining portion, a file encrypting portion 35, an electronic ticket generating portion 36, an encrypted file and electronic ticket sending portion 37, and a security policy/user information inputting portion 38.

The above-described confidential file is stored in a disk of the customer information management server 30 owned by the company A. The customer information of millions of customers is stored in a body of the confidential file on the customer information management server 30. The customer information includes name, birthday, address, and telephone number of each customer, information on customer's product purchase from the company A, customer's state of payment to the company A, and credit card number owned by each customer. In the event of leakage of the afore-mentioned customer information, there are concerns that the company A will lose confidence in society substantially, and besides, the damages suit for a large sum of money will be filed. Therefore, it is assumed that the confidential file having the customer information stored in the customer information management server 30 is encrypted with the use of 2,048-bit key for the RSA cryptosystem employed.

The user and device authenticating portion 31 authenticates the user who accesses the customer information management server 30. The security policy/user information inputting portion 38 acquires security guideline information that includes user eligibility information necessary for specifying a usable range of the user, a customer record estimate price used for determining the value of the confidential information, and the like, from the security server 40 on a communication network such as a LAN or the like. The customer record information limiting portion 32 limits a usable range of the confidential information on the basis of the user's eligibility. The key length determining portion 33 determines the length of the encryption key used for encrypting the electronic file, according to a processing ability of the user terminal 20.

The customer record number setting portion 34 determines the number of records to be encrypted by one encryption key, according to the processing ability of the user terminal 20 that displays the electronic file. To avoid the problem of delay in the processing period for viewing the encrypted file with the low-performance device such as a mobile telephone or the like, the customer record number setting portion 34 limits the number of records to be displayed on one screen of the user terminal 20 to that determined by the customer record number setting portion 34. The file encrypting portion 35 encrypts the electronic file having the customer records with the use of the encryption key having the length determined by the key length determining portion 33. The electronic ticket generating portion 36 generates an electronic ticket for the user terminal 20 with the use of device-specific information of the user terminal 20. The encrypted file and electronic ticket sending portion 37 sends the encrypted electronic file and electronic ticket to the user terminal 20.

The user terminal 20 is provided with user eligibility certification and device ID sending portion 21, an encrypted file and electronic ticket receiving portion 22, a confidential file decrypting portion 23, and a file displaying portion 24. The user terminal 20 is composed of, for example, a mobile telephone, Personal Digital Assistance (PDA), or the like. On the user terminal 20, and electronic certificate, smart card, or IC card can be used for certifying the eligibility for the electronic file. The user eligibility certification and device ID sending portion 21 sends the user eligibility certificate and a device ID that is the information specific to the device. The encrypted file and electronic ticket receiving portion 22 receives the encrypted file and the electronic ticket from the customer information management server 30. The confidential file decrypting portion 23 decrypts such encrypted file to a clear text.

In addition, it is assumed that the user terminal 20 has software tamper-resistant capabilities provided for preventing the leakage of the clear text, the encryption key, and the like (Reference: “Tamper Resistant Technology for Software”, IPSJ Magazine, Vol. 44, No. 6, June 2003). The file displaying portion 24 is mounted on the user terminal 20, as a viewer in which the security is ensured by the software tamper-resistant capabilities. The user B views the encrypted file with the use of the afore-mentioned viewer. It is assumed that an electronic ticket system (Japanese Patent Application Publication No. 10-164051 “A User Authentication Apparatus and a Method Therefor”) is employed to prevent unauthorized use or access to the file.

In the electronic ticket method assumed here, the user registers the information specific to the device owned by the user in the customer information management server 30. The customer information management server 30 issues, as the electronic ticket, the information related to the above-described device-specific information and the encryption key to be used for the protection of the confidential information. The above-described device-specific information is registered without the leakage of the device-specific information to the user or to the third party, after a program protected by the tamper-resistant capabilities of the device establishes a secure path such as a Virtual Private Network (VPN) for the communication with the customer information management server 30. The above-described software tamper-resistant capabilities always protect the above-mentioned device-specific information, the encrypted confidential file, and a shared key used for the encryption of the confidential file. This prevents the user and the third party from acquiring the afore-mentioned information from the device.

In the above-described electronic ticket system, the factoring problem or the discrete logarithm problem is utilized to prevent attackers from obtaining the secret information, such as the encryption keys. It is therefore impossible for the user or for the third party to calculate the information on the encryption key used for protecting the user's device-specific information or the confidential file in view of the computational complexity. Accordingly, the leakage of the confidential file and the accompanying confidential information can be prevented in practice.

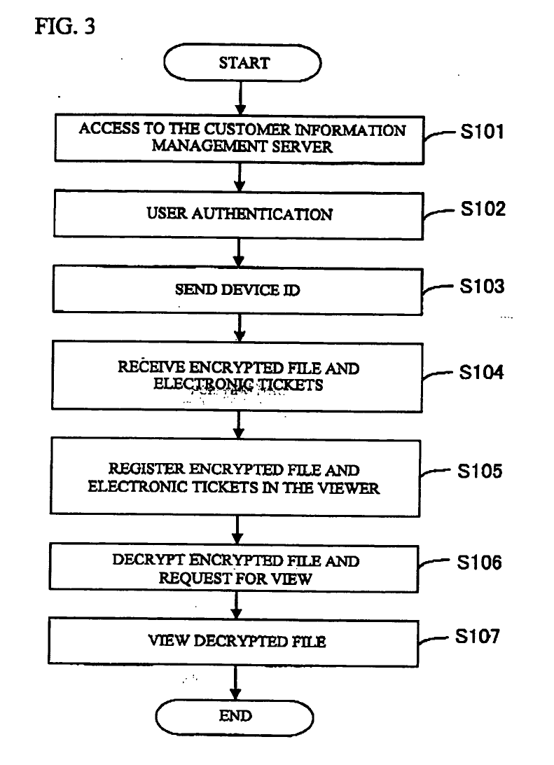

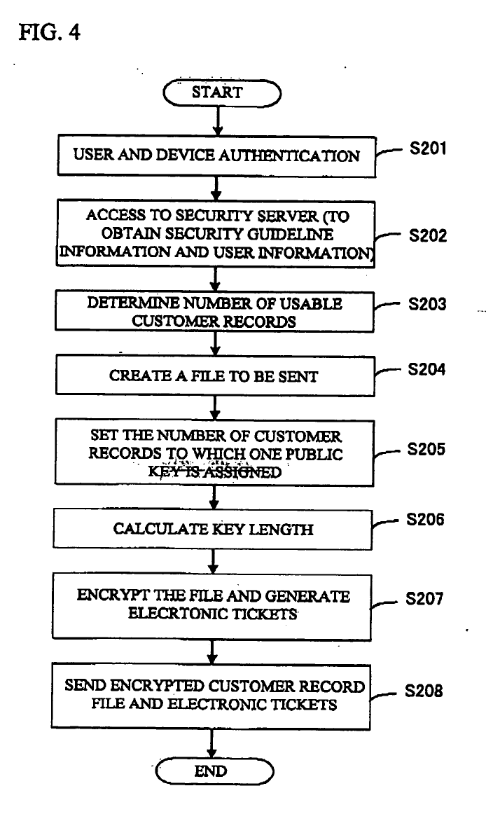

Referring now to FIG. 3 and FIG. 4, a description will be given of the procedure of the user terminal 20 and that of the customer information management server 30 to be implemented when the customer information is used. FIG. 3 shows a procedure to be implemented by the user who uses the electronic file. FIG. 4 shows a procedure of the customer information management server in which the electronic file is encrypted and the electronic ticket and the encrypted electronic file are sent.

The user B accesses the customer information management server 30 via the user eligibility certification and device ID sending portion 21 of the user terminal 20 at step S101. The user B provides use elibility of the customer information with the use of the electronic certificate or the like to the customer information management server 30 at step S102. Simultaneously, the user eligibility certification and device ID sending portion 21 sends the device ID to specify the device by which the user is going to use the customer information at step S103.

On the customer information management server 30, the user and device authenticating portion 31 performs the user authentication of the user B at step S201. When the user authentication is completed, the security policy/user information inputting portion 38 accesses the security server 40 to acquire security guideline information that includes the user information, the processing speed E of the user terminal 20, and a customer record estimate price v to be used for determining the value of the confidential file at step S202. The security guideline information acquired from the security server 40 includes an estimate value G of the number of CPU operations or cycles purchased by one yen and a protection period Y, in addition to the processing speed E.

The customer record information limiting portion 32 determines the usable range of the customer information of the user B, on the basis of the user information and the device ID at step S203. Here, M is set to the number of customers whose customer information can be used by the user B. Then, the confidential file having the customer records of M customers is created to be sent to the user B at step S204.

Specifically, the customer record information limiting portion 32 decrypts: the body of the confidential file that has been encrypted and stored, with the use of the 2,048-bit key. The customer records of M customers that can be viewed by the user B are extracted from such decrypted confidential file. Subsequently, the key length of the public key cryptosystem to be used for encrypting the customer record and a number N of the customer records to which one public key is assigned are calculated in the method described below at step S205. Firstly, the key length determining portion 33 calculates a key length k of the public key cryptosystem in an expression (1) with the use of the processing speed E of the user terminal 20 at step S206.
(1)k−(2E)ˆA (1/3)
The processing speed E of the user terminal 20 is determined by the processing ability of the user terminal 20. For example, when the CuP clock speed of the user terminal 20 is Cu (bit/second), E can be calculated by E=1/Cu.

The customer record number setting portion 34 then calculates the number N of the customer records to which one public key is assigned with the use of the customer record estimate price v and the estimate value G of the number of CPU operations that can be purchased by one yen in the following expression.
N=[C(k)/(v·f(Y))], f(Y)=G×(2ˆ(Y/1.5))
Here, it is assumed that [x] denotes a maximum integer that does not exceed x, and c(k) is a positive real number in the following expression.
c(k)=min{w|Ψ(x,y)>=xy/log y,x=2d(kˆ(2/d)) (wˆ((d+1)/2), y<0)
Here, Ψ(x,y) denotes the number of integers<=x with no prime factor>y, and d denotes a positive integer.

A method to evaluate Ψ(x,y) should be referred to [1] Transactions of the American Mathematical Society, Vol. 296, pp. 265-290, 1986, [2] Mathematics Computation, Vol. 66, pp.1729-1741, 1997, and [3] Mathematics Computation, Vol. 73, pp.1013-1022, 2003. Any of the afore-mentioned calculation methods employs the Hildebrand-Tenenbaum estimate equation. However, the calculation may be accelerated by employing the Newton-Cotes method in the calculation of the estimate equation. The Hildebrand-Tenenbaum estimate equation, which is employed when the key length determining portion 33 determines the length of the encryption key, is shown below.

$$Ψ ( x , y ) = \frac{{x}^{α} ζ ( α , y )}{α \sqrt{2 π {ϕ}_{2} ( α , y )}} ( 1 + O ( \frac{1}{u} + \frac{log y}{y} ) ) \qquad [ Equation 1 ]$$

In particular, the key length determining portion 33 may calculate an estimate value of the Hildebrand-Tenenbaum estimate equation, with the use of the following Newton-Cotes method. Here, n and e respectively denote an arbitrary positive integer and an arbitrary positive number. If the integers x and y satisfy the following expression
(logx)ˆ(1+ε)<y<=x,
then the following equation is held.

$$Ψ ( x , y ) = \frac{x exp ( γ + f ( l ) )}{\sqrt{2 π ( u - ( u - 1 ) / E ( l ) )}} ( 1 + O ( \frac{log ( 1 + u )}{log y} ) + u exp ( - {( log y )}^{3 / 5 - u} ) + \frac{1}{log ( 1 + u )} ) , \\ f ( m ) = {\sum }_{j = 0}^{m - 1} {\sum }_{k = 0}^{m} \frac{exp ( h ( j + k / n ) ) - 1}{h ( j + k / n )} {A}_{n , k} ( h j , h ( j + 1 ) ) , \\ {A}_{n , k} ( a , b ) = {\int }_{a}^{b} {{∐}^{n}}_{l = 0 , l \neq k} \frac{{x}_{s} - {x}_{p}}{{x}_{z} - {x}_{l}} ⅆ x , {x}_{l} = a + t ( b - a ) / n , u = \frac{log x}{log y}$$

$$h = E ( m ) / m , l = [ {u}^{1 / n} log y ] + 1$$

Subsequently, the file encrypting portion 35 generates [M/N]+1 secret keys and public keys of the RSA cryptosystem having the key length k, and also generates [M/N]+1 electronic tickets to be sent to the user terminal 20 with the use of the afore-mentioned secret keys and the device-specific information of the user terminal 20 owned by the user B. Then, the electronic ticket generating portion 36 generates [MIN]+1 random numbers,of 160 bits. Here, [M/N]+1 secret keys are represented by d(1), d(2), . . . , and d([M/N]+1), [M/N]+1 public keys are represented by e(1), e(2), . . . , and e([M/N]+1), and [M/N]+1 random numbers are represented by r(1), r(2), . . . , and r([M/N]+1).

The file encrypting portion 35 encrypts the electronic file having the customer record with the afore-described keys in the following manner at step S207. Firstly, the file encrypting portion 35 encrypts a first through N-th customer records with the common key of the random number r(1) by use of the symmetric key cryptosystem such as Advanced Encryption Standard (AES) or the like. Then, the file encrypting portion 35 encrypts the random number r(1) with the use of a public key e(1) to generate an encrypted symmetric key r′(1). The electronic ticket generating portion 36 generates an electronic ticket t(1) with the use of the encrypted shared key r′(1), a secret key d(1), and the device-specific information of the user terminal 20 to generate the electronic ticket t(1).

In a similar manner, an (N+1)-th through a 2N-th customer records are encrypted to generate an electronic ticket t(2) with the use of a random number r(2), a public key e(2), and a secret key d(2). A similar process is performed on records of (2N+1)-th and later to create an encrypted customer record file having the customer records of the whole M customers. The encrypted file and electronic ticket sending portion 37 attaches the encrypted shared keys r′(1), r′(2), . . . , and r′([M/N]+1) and the electronic tickets t(1), t(2), . . . , and t([M/N]+1) to the encrypted customer record file to send to the user terminal 20 at step S208.

A description will now be given of how the user B views the encrypted customer record file. When the encrypted file and electronic ticket receiving portion 22 of the user terminal 20 receives the encrypted file and the electronic tickets at step S104, the user B can view the encrypted customer record file on a viewer protected by the tamper-resistant capabilities as described above. The user B registers such obtained electronic tickets and the encrypted customer record file in the viewer at step S105. The viewer decrypts the encrypted symmetric keys r′(1), r′(2), . . . , and r′(M/N)+1) attached to the encrypted customer record file, with the use of the electronic tickets t(1), t(2), . . . , and, t([M/N]+1) and the device-specific information to obtain symmetric keys r(1), r(2), . . . , and r([M/N]+1). Subsequently, the confidential file decrypting portion 23 decrypts the encrypted customer record file with the use of the symmetric keys r(1), r(2), . . . , and r ([M/N]+1), and the file displaying portion 24 displays to the user at steps S106 and S107. However, the above-described processes are implemented with all confidential information retained within an area covered by the tamper-resistant capabilities owned by the viewer.

It is impossible for the user to learn any information on the symmetric keys r(1), r(2), . . . , and r([M/N]+1) or the device-specific information in view of the computational complexity. However, once the electronic ticket is obtained, it is possible for the user to view the information in the encrypted customer record file on a dedicated viewer mounted on the device used by the user within a validity period, even if the user utilize the device in a mobile environment outside of the company, from which the user cannot access the customer information management server 30.

Here, in the above-described equations, it is assumed that the customer record estimate price v is 10,000, the number of the pieces of the customer information M is 1,000 customers, the protection period Y is 10 years, and the estimate value G of the number of CPU operations purchased by one yen is 1.00915×10ˆ11 bits. Here, the value of G is calculated on the assumption that a sales price of a 3.2 GHz personal computer (PC) is 200,000 yen (Reference literature is Simson Garfinkel, “PGP: Pretty Good Privacy”, O'Reilly, 1994). It is also assumed that the computational complexity needed for decryption of the RSA cryptosystem is (1/2) kˆ3 and 150 MHz is the Central Processing Unit (CPU) clock speed of the mobile telephone used by the user. At this time, 699 bits is the key length for the mobile telephone, and 14 is the number N of the customer records to which one public key is assigned. The key length is 0.32 times as long as 2,048 bit of RSA encryption key used on the customer information management server 30.

The time needed for decryption with the RSA cryptosystem is proportional the cube of the key length. Accordingly, when it is assumed that the number of the customer records displayed on one screen of the mobile telephone is limited to 14 customers, approximately 30 times is substantially speeded up with the use of the above-described method. This enables usability to be improved in viewing the confidential file, and in addition, realizes a robust protection of copyright and confidential information by using a low-speed device such as a mobile telephone or the like.

In particular, in a case where a highest-level robust protection system is established with the use of the electronic ticket method, it can be assumed to establish such a system that only one page to be displayed on the viewer is decrypted in the area covered by the tamper-resistance capabilities and the portion that is not displayed is retained with remaining encrypted, instead of decrypting the whole file at the time of displaying the file on the viewer. In the afore-described case, the decryption with the public key cryptosystem is performed whenever one page is displayed, therefor generally lowering the speed and degrading the usability to a large degree. For this reason, in a case where such a highest-level robust protection system is established with the low-speed device such as a mobile telephone, the method employed according to an exemplary embodiment of the present invention has a profound effect on speeding up.

According to an exemplary embodiment of the present invention, RSA cryptosystem is utilized for the protection of the confidential file, in particular. A similar effect is obtainable by utilizing another public key crypto systems such as ElGamal cryptosystem, elliptic curve cryptosystem, or NTRU. When setting the number of the records in the file that the user is allowed to view, an estimate of the time needed for decryption with a supposed device such as a PC may be provided to the user as reference information so that the user can adjust the setting range.

The user terminal 20, the customer information management server 30, and the security server 40 are realized by use of a CPU, Read Only Memory (ROM), Random Access Memory (RAM) and the like. The information management method is realized by the customer information management server 30, according to an exemplary embodiment of the present invention. The information management method can be realized as a program that is executed by controlling the computer. This program can be provided by storing in a magnetic disk, optical disk, semiconductor memory, or another type of storage media, or delivering on a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information management system comprising a determining portion that determines the number of pieces of information to be encrypted by an encryption key, depending on a processing ability of an information terminal that displays an electronic file, in which one or more pieces of the information are stored and encrypted for delivery.

2. The information management system according to claim 1, further comprising a key length determining portion that determines a length of the encryption key, depending on the processing ability of the information terminal.

3. The information management system according to claim 2, wherein the key length determining portion employs Hildebrand-Tenenbram estimate equation in determining the length of the encryption key.

4. The information management system according to claim 3, wherein the Hildebrand-Tenenbaum estimate equation is calculated with the use of Newton-Cotes method.

5. The information management system according to claim 1, wherein the information includes customer information.

6. The information management system according to claim 1, wherein the processing ability of the information terminal is evaluated as a CPU processing speed.

7. The information management system according to claim 1, wherein the information to be displayed on one screen of the information terminal is limited to the number of pieces of the information determined by the determining portion.

8. The information management system according to claim 1, further comprising an information terminal that decrypts the electronic file encrypted for view.

9. The information management system according to claim 1, further comprising a generating portion that generates an electronic ticket for the information terminal.

10. The information management system according to claim 1, wherein the electronic file is protected by a tamper-resistant technique.

11. The information management system according to claim 1, wherein at least any one of an electronic certificate, a smart card, and an IC card is used for certifying use eligibility of the electronic file.

12. An information management method comprising determining the number of pieces of information to be encrypted by an encryption key, depending on a processing ability of an information terminal that displays an electronic file, in which one or more pieces of the information are stored and encrypted for delivery.

13. The information management method according to claim 12, further comprising determining a length of the encryption key, depending on the processing ability of the information terminal.

14. A computer readable medium storing a program causing a computer to execute a process for information management, the process comprising determining the number of pieces of information to be encrypted by an encryption key, depending on a processing ability of an information terminal that displays an electronic file, in which one or more pieces of the information are stored and encrypted for delivery.
